(19) United States
(12) Patent Application Publication
(10) Pub. No.: US 2013/0163646 A1
(43) Pub. Date: Jun. 27, 2013

(54) ELECTRONIC DEVICE HAVING SIGNAL-EQUALIZING SYSTEM AND METHOD FOR SETTING THE SIGNAL-EQUALIZING SYSTEM

(71) Applicants: YING-TSO LAI, Tu-Cheng (TW); HSIAO-YUN SU, Tu-Cheng (TW); DAN-CHEN WU, Tu-Cheng (TW); SHIN-TING YEN, Tu-Cheng (TW)

(72) Inventors: YING-TSO LAI, Tu-Cheng (TW); HSIAO-YUN SU, Tu-Cheng (TW); DAN-CHEN WU, Tu-Cheng (TW); SHIN-TING YEN, Tu-Cheng (TW)

(73) Assignee: HON HAI PRECISION INDUSTRY CO., LTD., Tu-Cheng (TW)

(21) Appl. No.: 13/548,223

(22) Filed: Jul. 13, 2012

(30) Foreign Application Priority Data
Dec. 27, 2011 (TW) 100148854

(51) Int. Cl. H04L 27/01

(52) U.S. Cl. 375/219

(57) ABSTRACT

A method for setting a signal-equalizing system for use in an electronic device includes the following steps. Outputting a connection status of each channel and a number of misconnect options respectively associated with each channel to a display unit of the electronic device. Then, detecting whether at least one misconnect option is selected. If yes, determining a misconnected channel and adjusting the receiving setting for the receiving port of the misconnected channel to match with the transmitting setting for the transmitting port of the misconnected channel according to settings for each channel stored in the electronic device. The stored settings for each channel include a transmitting setting for the transmitting port of the channel and a receiving setting for the receiving port of the channel that matches the transmitting setting.

### BACKGROUND

1. Technical Field

Embodiments of the present disclosure generally relate to electronic devices and, and more particularly to an electronic device having a signal-equalizing system and method of setting the signal-equalizing system.

2. Description of Related Art

An equalizer is utilized for reducing and compensating for distortion during the transmission of signals between a transmitter and a receiver, such as a processing chip and a display chip in a computer system. When using the equalizer, settings for the transmitting ports of the transmitter and the receiving ports of the receiver, are very important. Typically, the compensation quality of the signals can be optimized in a channel when the transmitting setting for the transmitting port of the channel matches the receiving setting for the receiving port of the channel. The settings for the equalizer are pre-stored in an input/output system (BIOS) of the computer system, such that the equalizer can obtain the settings from BIOS after booting up.

However, the transmitting ports may be misconnected to the receiving ports, as shown in FIG. 1 where the transmitting port 201 of one channel of the multi-channel transmitter 2 is not connected to the corresponding receiving port 301 of the same channel of the multi-channel receiver 3, but instead is connected to the receiving port 302 of another channel. If the equalizer directly obtains the stored transmitting setting for the transmitting port 201 and the stored receiving setting for the receiving port 302 and then assigns the obtained settings for the misconnected channel, the compensation of the signals in the misconnected channel may obviously not be adequately matched.

Therefore, what is needed is an electronic device to overcome the described shortcomings.

### BRIEF DESCRIPTION OF THE DRAWINGS

FIG. 1 is a schematic diagram of a connection status between a transmitter and a receiver of an electronic device of a related art.

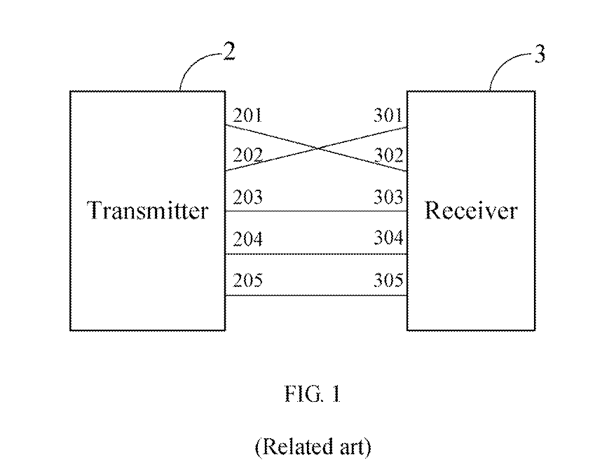

FIG. 2 is a schematic diagram of an electronic device having a signal-equalizing system, in accordance with an embodiment.

FIG. 3 is a schematic diagram of a connection status between a transmitter and a receiver in the electronic device of FIG. 2.

FIG. 4 is similar to FIG. 3, but showing a misconnection status between the transmitter and the receiver.

FIG. 5 is a block diagram of the signal-equalizing system of FIG. 2.

FIG. 6 is a flowchart of a method for setting a signal-equalizing system, in accordance with an embodiment.

### DETAILED DESCRIPTION

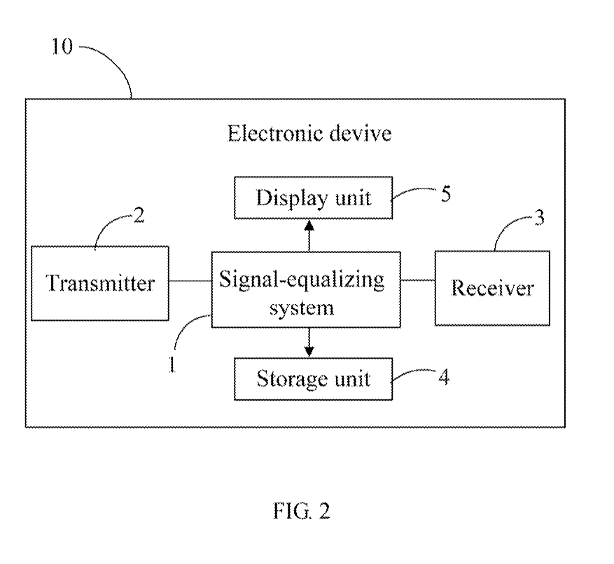

FIG. 2 is a schematic diagram of an electronic device 10 having a signal-equalizing system 1, in accordance with an exemplary embodiment. The electronic device 10 can be a computer or a server, and includes a transmitter 2 and a receiver 3. The signal-equalizing system 1 is applied between the transmitter 2 and the receiver 3, and is connected to the transmitting ports of the transmitter 2 and the receiving ports of the receiver 3. It should be appreciated that each of the transmitter 2 and the receiver 3 is multi-channel, thus a large amount of signals may be transmitted between the transmitter 2 and the receiver 3.

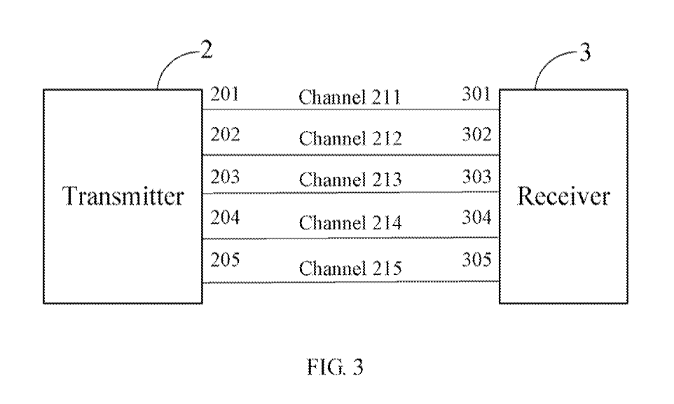

FIG. 3 schematically shows five channels 211-215 between the transmitter 2 and the receiver 3 as an example. That is, the transmitter 2 includes five transmitting ports 201-205, and the receiver 3 includes five receiving ports 301-305. The transmitting ports 201-205 are set to correspond to the receiving ports 301-305, thus the five channels 211-215 are formed. Each channel is set with corresponding settings, including a transmitting setting for the transmitting port of the channel and a receiving setting for the receiving port of the channel that matches with the transmitting setting. The settings for the channels are stored in a storage unit 4 of the electronic device 10, such as a basic input/output system (BIOS), thus the signal-equalizing system 1 can obtain the corresponding stored settings for each channel when transmitting the signals. Each channel can obtain an optimal compensation of the signals using its corresponding settings, namely, the transmitting and the receiving settings for the channel that match each other

In this embodiment, different settings are assigned different names such as 1T, 2T etc. for the transmitting settings of the transmitting ports and 1R, 2R etc. for the receiving settings of the receiving ports. For example, the transmitting and the receiving settings for the channel 211 are respectively set to be 1T and 1R, and the transmitting and the receiving settings for the channel 212 are respectively set to be 2T and 2R, and so forth. Then, the set settings associated with the corresponding channel are stored in the storage unit 4, for example, the settings 1T and 1R associated with the channel 211, and the settings 2T and 2R associated with the channel 212, are stored in the storage unit 4. After booting up, the signal-equalizing system 1 obtains the corresponding settings for each channel, thereby ensuring that the channels can transmit the signals effectively.

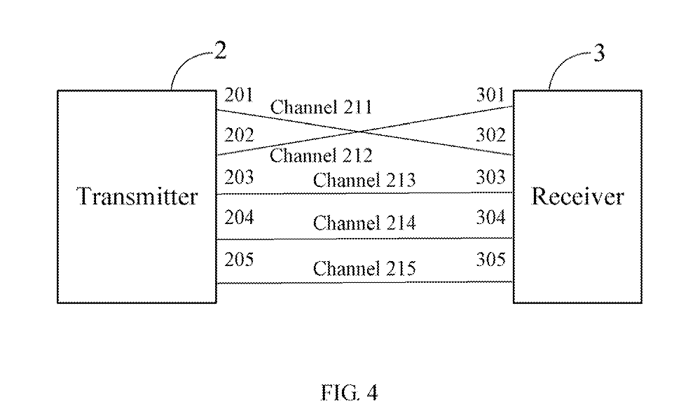

FIG. 4 schematically shows that the transmitting port 201 of the channel 211 is misconnected to the receiving port 302 of the channel 212, and the transmitting port 202 of the channel 212 is misconnected to the receiving port 301 of the channel 211. If the signal-equalizing system 1 directly obtains the transmitting and receiving settings 1T and 1R respectively for the transmitting port 201 and the receiving port 301, and the transmitting and receiving settings 2T and 2R respectively for the transmitting port 202 and the receiving port 302, then the misconnected channel 211 uses 1T and 2R as its settings, and the misconnected channel 212 uses 2T and 1R as its settings. In this case, the signals transmitted over the misconnected channel 211 may not be optimally compensated because the transmitting and receiving settings for the transmitting port 201 and the receiving port 302 do not match each other.

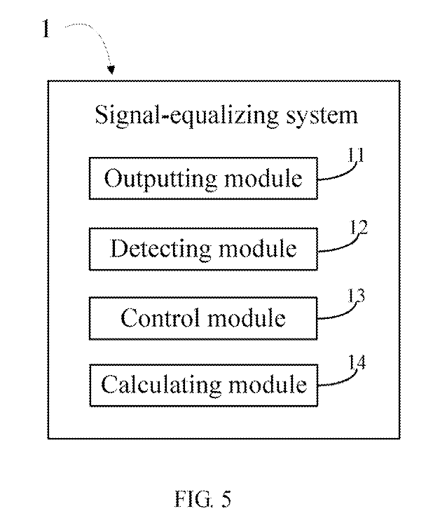

FIG. 5 is a block diagram of the signal-equalizing system 1 that allows each misconnected channel to obtain matching settings, in accordance with an exemplary embodiment. In the embodiment, the signal-equalizing system 1 includes an outputting module 11, a detecting module 12, and a control module 13.

The outputting module 11 outputs the connection status of each channel between the transmitter 2 and the receiver 3 via a display unit 5 of the electronic device 10 to allow users to determine whether the transmitting port of each channel is correctly connected to the corresponding receiving port of the same channel. Moreover, the outputting module 11 outputs a number of misconnect options respectively associated with the channels via the display unit 5. After determining that any channel is misconnected, the user can select the misconnect option corresponding to the determined misconnected channel.

The detecting module 12 detects whether at least one misconnect option is selected, if so, the detecting module 12 generates a detecting signal.

The control module 13 determines the misconnected channel in response to the detecting signal, and adjusts the receiving setting for the receiving port of the misconnected channel to match with the transmitting setting for the transmitting port of the misconnected channel according to the settings associated with each channel stored in the storage unit 4, such that the signal-equalizing system1 can correctly obtain matching settings for the determined misconnected channel from the storage unit 4.

For example, after determining that the channels 211, 212 are misconnected, the user can select the misconnect option corresponding to the channels 211, 212. Then the control module 13 adjusts the receiving setting for the receiving port 302 to be 1R according to the transmitting setting for the transmitting port 201, and adjusts the receiving setting for the receiving port 301 to be 2R according to the transmitting setting for the transmitting port 202.

In the embodiment, the system 1 further includes a calculating module 14. The calculating module 14 calculates the settings for each channel, and then the control module 13 controls the storage unit 4 to store the calculated settings. The calculating module 14 may be an ALLEGRO PCB SI simulation software, an ADS simulation software, or a SPEED simulation software.

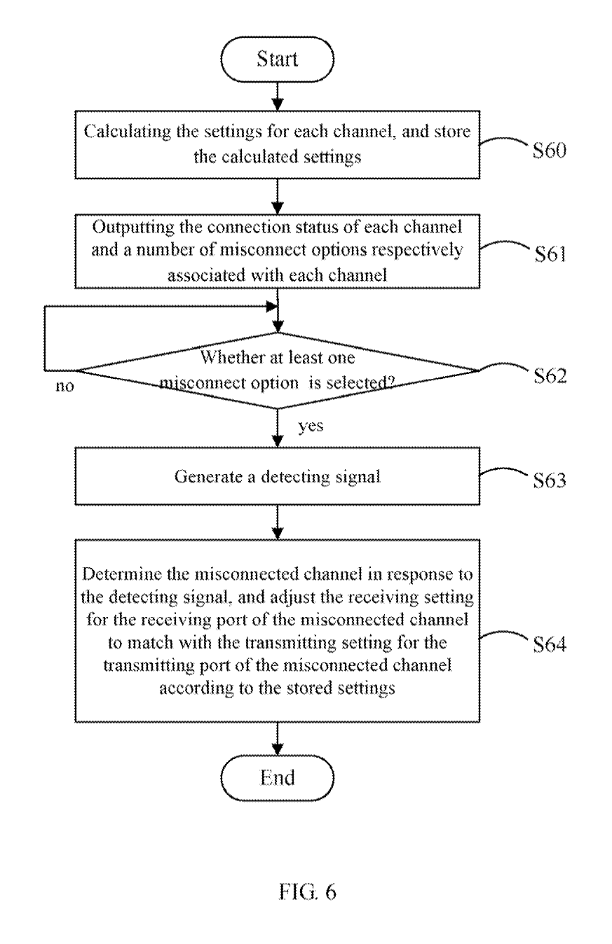

FIG. 6 is a flowchart illustrating a method of setting the signal-equalizing system 1, according to an exemplary embodiment.

In step S60, the calculating module 14 calculates the settings for each channel, and then the control module 13 controls the storage unit 4 to store the calculated settings.

In step S61, the outputting module 11 outputs the connection status of each channel between the transmitter 2 and the receiver 3 and a number of misconnect options respectively associated with each channel via the display unit 5.

In step S62, the detecting module 12 detects whether at least one misconnect option displayed by the displayed unit 5 is selected, if so, the procedure goes to step S63; otherwise, the procedure goes back to step S62.

In step S63, the detecting module 12 generates a detecting signal.

In step S64, the control module 13 determines the misconnected channel in response to the detecting signal, and adjusts the receiving setting for the receiving port of the misconnected channel to match with the transmitting setting for the transmitting port of the misconnected channel according to the settings associated with each channel stored in the storage unit 4.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device comprising:
a transmitter comprising a plurality of transmitting ports;
a receiver comprising a plurality of receiving ports respectively connected to the transmitting ports, wherein each receiving port and the corresponding transmitting port forms a channel;
a storage unit to store a plurality of settings for each channel, the settings comprising a transmitting setting for the transmitting port of each channel and a receiving setting for the receiving port of each channel that matches the transmitting setting;
a display unit; and
a signal-equalizing system connected to the transmitting ports and the receiving ports, the signal-equalizing system comprising:
an outputting module to output a connection status of each channel and a plurality of misconnect options respectively associated with each channel to the display unit for display;
a detecting module to detect whether at least one misconnect option is selected, and to generate a detecting signal if at least one misconnect option is selected; and
a control module to determine a misconnected channel in response to the detecting signal, and adjust the receiving setting for the receiving port of the misconnected channel to match with the transmitting setting for the transmitting port of the misconnected channel according to the stored settings, thereby allowing the signal-equalizing system to obtain matching settings for the determined misconnected channel from the storage unit.

2. The electronic device of claim 1, wherein the storage unit is a basic input and output system, and the signal-equalizing system obtains the corresponding stored settings for each channel from the basic input and output system when transmitting the signals.

3. The electronic device of claim 1, wherein the calculating module further comprises a calculating module configured for calculating the settings for each channel, and the control module is further configured for controlling the storage unit to store the calculated settings.

4. The electronic device of claim 3, wherein the calculating module is an ALLEGRO PCB SI simulation software, an ADS simulation software, or a SPEED simulation software.

5. A method for setting a signal-equalizing system for use in an electronic device, the electronic device comprising a transmitter and a receiver, the transmitter comprising a plurality of transmitting ports, the receiver comprising a plurality of receiving ports respectively connected to the corresponding transmitting ports, each receiving port and the corresponding transmitting port forming a channel, the signal-equalizing system connected to the transmitting ports and the receiving ports, the method comprising:
outputting a connection status of each channel and a plurality of misconnect options respectively associated with each channel to a display unit of the electronic device for display;
detecting whether at least one misconnect option is selected, and generating a detecting signal if at least one misconnected option is selected;
determining a misconnected channel in response to the detecting signal; and
adjusting a receiving setting for the receiving port of the misconnected channel to match with a transmitting setting for the transmitting port of the misconnected channel according to settings for each channel stored in the electronic device, thereby allowing the signal-equalizing system to obtain matching settings for the determined misconnected channel from the electronic device, wherein the stored settings for each channel comprise a transmitting setting for the transmitting port of the channel and a receiving setting for the receiving port of the channel that matches the transmitting setting.
